(19) United States
(12) Patent Application Publication
(10) Pub. No.: US 2007/0049379 A1
(43) Pub. Date: Mar. 1, 2007

(54) Flexible coupling device

(75) Inventors: Robert Lewis Faass, Utica, NY (US); Robert Herbert Findlay, Whitesboro, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Simmonds Precision Products, Inc.

(21) Appl. No.: 11/215,366

(22) Filed: Aug. 30, 2005

(51) Int. Cl. F16D 3/00

(52) U.S. Cl. 464/79

(57) ABSTRACT

A flexible coupling device for transmitting power between at least two adjoining rotary members and allowing axial deflection and/or angular misalignment of at least one rotary member relative to another. The flexible coupling device provides optimization for both bending and torque stress. The flexible coupling device includes at least two annular members where the thinnest point of the flexure portion of at least one of the annular members is spaced radially-inward from the radially-outermost point. Additionally, the components of the device are unitary in structure and may be constructed using cost-efficient manufacturing processes.

### FIELD OF THE INVENTION

The present invention is directed to couplings for connecting rotatable members, and more particularly to flexible couplings that transmit power and accommodate angular and/or axial misalignments between adjoining rotatable members.

### BACKGROUND OF THE INVENTION

Drive systems serve as the crux of many industrial machines. In order to be commercially efficient, it is important that these drive systems not only operate effectively, but that their subsystems and individual parts do so at an efficient cost. Drive systems often include power transmission couplings. Typically, power transmission couplings transmit power from an engine to a gearbox or from a rotatable driving shaft to a rotatable driven shaft. These shafts are often angularly misaligned, axially misaligned, or both. As a result, power transmission couplings are critical components in industrial applications, especially transportation applications such as the drive systems of fixed-wing and rotary-wing aircraft. These applications involve both high torque and high bending stress requirements. In addition to satisfying these requirements, it is also advantageous that these couplings are inexpensive to manufacture.

Flexible transmission couplings are commonly used in these applications. Typical flexible couplings include a flexible diaphragm member with a wall thickness that decreases with increasing radial distance from the center. Because torque transmitting capacity varies inversely with the square of the radius of the diaphragm, the purpose of this profile is to maintain constant shear stress throughout the thickness of the diaphragm member so that the weight of the device may be minimized.

In order to produce this profile, a typical diaphragm member is manufactured with contours produced on both sides of the member. The contours may be created using electro-chemical machining, which is helpful in allowing two neighboring annular members of a diaphragm to be formed with a cavity therebetween defined by the contours. To produce the flexible coupling, the diaphragm members may be joined to each other or to appropriate flanges, fittings, or tubes by means of electron beam welding. However, these processes are costly and time consuming. Additionally, because the bending stresses increase as the radius increases, a wall thickness profile that maintains constant shear stress throughout the thickness of the diaphragm member does not optimize the bending stresses of the flexible coupling.

Thus, there remains a need for a commercially efficient coupling device for use in transmitting power between rotary members that are axially and/or angularly misaligned. The device should be constructed of unitary parts and should be able to be optimized for the high torque and bending requirements of power transmission between members. The device should also use cost-efficient manufacturing processes, thus resulting in a simplified, less expensive flexible coupling.

### BRIEF SUMMARY OF THE INVENTION

The present invention addresses the above needs and achieves other advantages by providing a simplified flexible coupling device for transmitting power between at least two adjoining rotary members and allowing axial deflection and/or angular misalignment of at least one rotary member relative to another. The flexible coupling device provides optimization for both bending and torque stress. The flexible coupling device includes at least two annular members having the thinnest point of the flexure portion of at least one annular member spaced radially-inward from the radially-outermost point. Additionally, the components of the device are unitary in structure and may be constructed using inexpensive manufacturing processes.

In one embodiment, the present invention includes a hub portion and at least two flexible adjacent annular members extending radially outwardly from the hub portion. The annular members comprise at least one radially-outward connecting portion for connecting each diaphragm to an adjoining diaphragm or rotary member. The annular members also comprise a flexure portion extending radially between the hub portion and the connecting portion of the respective annular member. The flexure portion comprises an outer side and an inner side, and the inner and outer sides of at least one flexure portion define a thickness. The thinnest point of the thickness is spaced radially-inward from the radially-outermost point of the flexure portion. Also, the inner sides of the adjacent annular members of a diaphragm face each other so as to define a flexure space that does not narrow in a radially-outward direction when the annular members are in an unflexed condition.

In one aspect, the thinnest points of adjacent flexure portions are substantially aligned in a radial direction. In another aspect, a continuous curve may define the outer side of at least one flexure portion. The connecting portion may be located at the radially-outermost point of the flexure portion, and the connecting portion may extend axially in one direction and radially outward from the flexure portion

The present invention also provides a method of manufacture for a unitary diaphragm of a flexible coupling device for transmitting power between at least two adjoining rotary members and allowing axial misalignment of at least one rotary member relative to another. The method of manufacture comprises forming outer sides of flexure portions of at least two annular members that extend radially outwardly from a diaphragm. The method also includes forming a flexure space that does not narrow and that defines inner sides of adjacent annular members, where the inner and outer sides of at least one flexure portion define a thickness for the flexure portion, and the thinnest point of the flexure portion is spaced radially-inward from the radially-outermost point of the flexure portion.

In one aspect, the method includes forming the unitary diaphragm using conventional manufacturing means. In another aspect, the method includes forming the outer sides of at least one flexure portion so that the outer side is defined by a continuous curve. In another aspect, the method includes forming a connecting portion located at the radially-outermost point of the flexure portion. The method may also include forming a connecting portion that extends axially in one direction and radially outward from the flexure portion.

The flexible coupling device of the present invention has several advantages that provide a simplified and commercially efficient coupling device for use in transmitting power between rotary members that are axially and/or angularly misaligned. The flexure portions, which include substantially straight inner sides and outer sides that have a first portion and a second portion, advantageously have the thinnest portion of the thickness at a transition point that is radially inside of the outer-most point of the flexure portion. This positioning allows optimization of both the torque and bending stresses. Additionally, the diaphragm is constructed of a unitary part. Although in certain circumstances it may still be advantageous to do so, this obviates the need for electron beam welding of adjacent coupling parts used in conventional coupling devices. Also, the flexure space does not narrow in a radially-outward direction. This allows the machining or forming of the flexure space to be more simplified, and thus less expensive and more commercially efficient. It also advantageously requires contouring of only the outer sides of the flexure portion of the diaphragm. Although conventional methods may be used, this results in the ability to use methods less expensive and time consuming than the conventional electro-chemical machining.

### BRIEF DESCRIPTION OF THE DRAWINGS

Having thus described the invention in general terms, reference will now be made to the accompanying drawings, which are not necessarily drawn to scale, and wherein:

FIG. 1 shows a side view of one embodiment of the present invention having multiple diaphragms and two end connecting members attached to two rotary members;

FIG. 2 shows a sectional view of the present invention having one diaphragm; and

FIG. 3 shows a close-up sectional view of the present invention shown in FIG. 2 on one side of the axis of rotation.

### DETAILED DESCRIPTION OF THE INVENTION

The present invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements. Like numbers refer to like elements throughout.

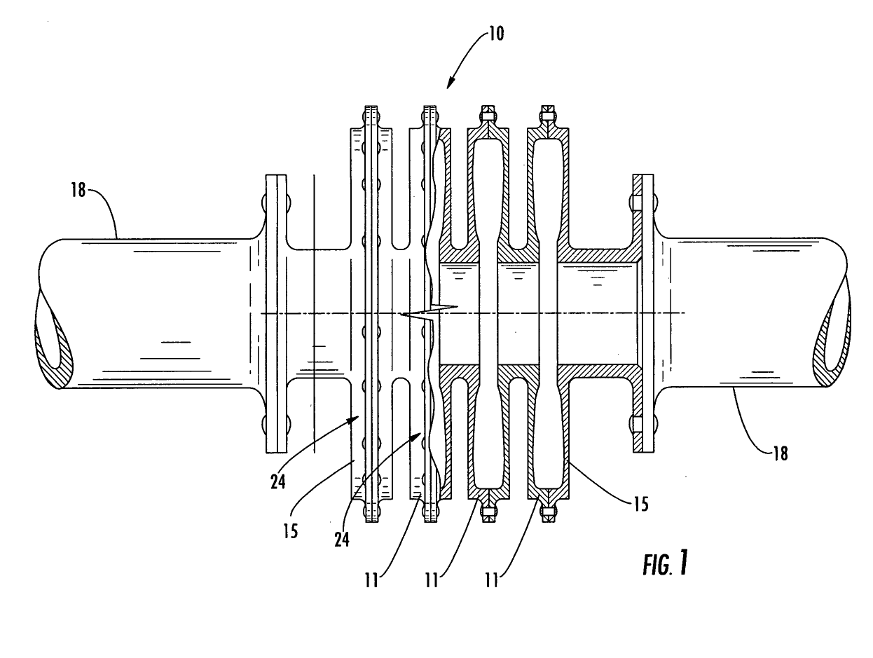

Generally the present invention in one embodiment includes a flexible coupling device 10 having one or more diaphragms 11. A flexible coupling device with multiple diaphragms 11 and two end connecting members 15 is shown in FIG. 1. Advantageously, the flexible coupling device provides optimization for both bending and torque stress between at least two adjoining rotary members 18.

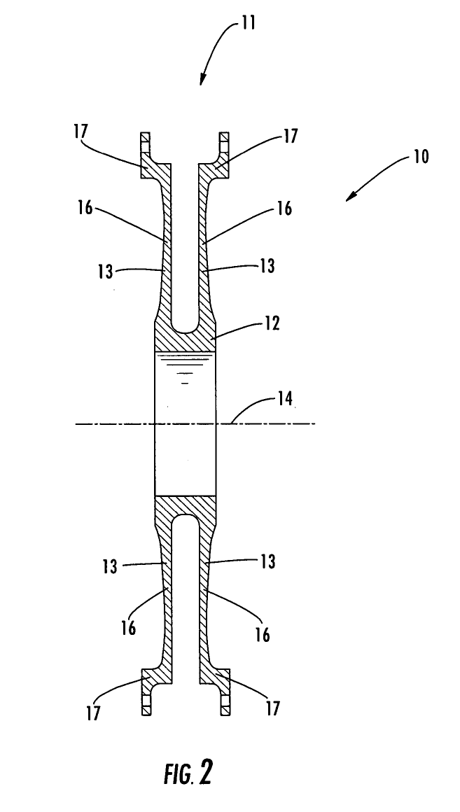

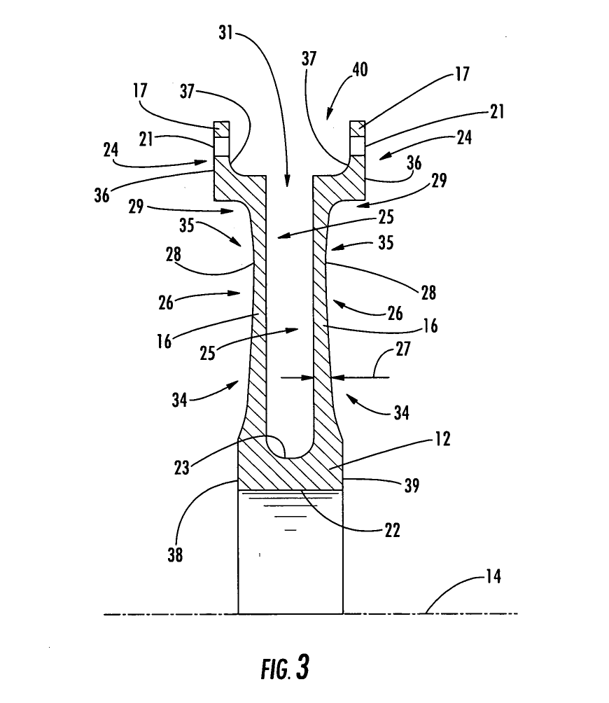

The flexible coupling device 10 is created from bar stock, but may be fabricated in any way, including by forging. It is constructed of a low-alloy steel, such as Inconel, but may also be made of other materials suitable for sustaining the required bending and torque stresses such as such as maraging steel, stainless steel, and titanium alloy. A cross section of diaphragm 11 of the flexible coupling device 10 is shown in FIGS. 2 and 3. The diaphragm 11 is generally disk-shaped and has a hub portion 12 and at least two annular members 13. The hub portion 12 is generally cylindrical in shape with a center axis that is generally co-linear with an axis of rotation 14 of the flexible coupling device 10 when the coupling device is not being flexed. The hub portion 12 includes an inner hub wall 22, a left hub surface 38, a right hub surface 39, and an outer hub wall 23. The left hub surface 38 and the right hub surface 39 are substantially parallel to each other and generally perpendicular to the axis of rotation 14. The center of the hub portion 12 is cut out such that an inner hub wall 22 is defined at some distance from the axis of rotation 14 of the flexible coupling device 10 as shown in FIG. 3.

It should be noted that in other embodiments of the present invention a wide range of variations in the structure of the hub portion 12 are possible. For example, the hub portion 12 could be continuous such that no section of the hub portion 12 is cut out, resulting in no inner hub wall 22. Alternatively, the left hub surface 38 and/or the right hub surface 39 need not be perpendicular to the axis of rotation 14. For example the left hub surface 38, the right hub surface 39, or both the left hub surface 38 and the right hub surface 39 could have positive slopes such that they angle away from each other, or they could have negative slopes such that they angle back toward each other.

Referring to FIG. 3, the annular members 13 extend radially outward from the hub potion 12 and, include a flexure portion 16 and a connecting portion 17. The flexure portion 16 extends radially outward from the hub portion 12 to a flexure end 29. The connecting portion 17 is located at the radial end of the flexure portion 16 and extends axially in one direction and radially outward from the flexure end 29 so as to define connecting rings 24, as shown in FIGS. 1 and 3. This shape provides more axial space between adjacent flexure portions than connecting members that extend only radially, which allows more angular misalignment in the coupling device.

The connecting rings 24 have an outer connecting surface 36 and an inner surface 37. The outer connecting surface 36 and the inner surface 37 are substantially parallel to each other and are generally perpendicular to the axis of rotation 14. The outer connecting surfaces 36 of the connecting rings 24 of the annular members 13 are located radially outside of the right hub surface 38 and the left hub surface 39, respectively. The connecting portion 17 also includes connecting holes 21. The connecting holes 21 are generally cylindrical in shape and are spaced along the periphery of the connecting rings 24. The connecting holes 21 extend from the outer connecting surface 36 through the inner surface 37 such that the axes of the connecting holes 21 are generally parallel to the axis of rotation 14. As shown in FIG. 1, the connecting holes 21 permit the use of fasteners, such as rivets, bolts, etc. to connect the diaphragm 11 to an adjoining diaphragm 11 or to end connecting member 15. The connecting portion 17 also permits connection directly to other rotary members 18.

Other embodiments of the flexible coupling device 10 may include multiple diaphragms 11. For example, a flexible coupling device 10 may comprise several diaphragms 11 adjacent to each other and attached at the connecting portion 17 as shown in FIG. 1. Other variations in the structure of the connecting portion 17 are also possible. For example, the outer connecting surface 36 and the inner surface 37 need not be parallel to each other. Also, other means for connecting the connecting portion 17 to adjoining diaphragms 11 or other rotary members 18 are possible, such as welding or brazing.

Referring to FIG. 3, the flexure portions 16 include inner sides 25, outer sides 26, and a thickness 27 defined between the inner sides 25 and the outer sides 26. The outer sides 26 have a first portion 34 of decreasing thickness extending from the hub portion 12 radially outward to a transition point 28. From the transition point 28, the outer sides 26 have a second portion 35 of increasing thickness that extends radially outward to the flexure end 29. The inner sides 25 of the flexure portion 16 are generally perpendicular to the axis of rotation 14 and are substantially straight such that the inner sides 25 of adjacent flexure portions 16 are substantially parallel and are generally perpendicular to the axis of rotation 14. The resulting transition point 28 defines the thinnest portion of the thickness 27 along the flexure portion 16.

Because torque transmitting capacity varies inversely with the square of the radius of the diaphragm, conventional flexible couplings that have the thinnest portion of the diaphragm member at the radially-outermost point from the hub are designed primarily to maintain constant shear stresses radially while minimizing weight. The result is that large bending stresses are created at the thinnest portions because the larger bending moments occur at the radially-outermost points. However, smaller bending moments occur at points that lie in-between the hub and the radially-outermost points. Thus, the flexible coupling device 10 of the present invention places the thinnest point of the flexure portion 16 at a point of lower bending stress, radially-outward from the hub portion 12 and radially-inward from the radially-outermost point. For example, the thinnest point of the flexure portion 16 may be placed at a point that is 40%-80% of the radius dimension. As a result, the diaphragm 11 can be optimized for bending stresses as well as for shear stresses, as is likewise stated in U.S. Pat. No. 5,158,504 to Stocco, the entire contents of which are hereby incorporated by reference.

It should be noted that although the illustrated embodiment includes certain profiles of the outer sides 26, the outer sides 26 could also have any profile, whether curved, straight, or combinations of both, and still contain a transition point 28 that defines the thinnest portions of the thickness 27 radially-inward from the radially-outermost point of the flexure portion 16.

A generally u-shaped flexure space 31 is defined by the outer hub wall 23 and the inner sides 25 of adjacent flexure portions 16. The flexure space 31 extends radially outward from the outer hub wall 23 and does not narrow in a radially-outward direction (when the annular members are in an unflexed condition). Likewise, a generally u-shaped connecting space 40 extends radially outward from the flexure space 31 and is defined by the inner connecting surfaces 37 of adjacent flexure portions 16. The fact that the flexure space 31 does not narrow in a radially-outward direction means that the inner sides 25 do not have undercut sections in the radial direction. This makes the flexible coupling device 10 easier to fabricate, and thus makes it easier to use conventional machining methods including, but not limited to turning, facing, or boring, to form the flexure space 31. It should be noted, however, that neither the flexure space 31, nor the connecting space 40 need be generally u-shaped. For example, the distance between the inner sides 25 of adjacent annular members 13 could increase radially outward such that the flexure space 31 is generally v-shaped. Likewise, the distance between the inner surfaces 37 of adjacent annular members 13 could increase radially outward such that the connecting space 40 is generally v-shaped.

The flexible coupling device 10 of the present invention has several advantages that provide a simplified and commercially efficient coupling device for use in transmitting power between rotary members that are axially and/or angularly misaligned. The flexure portions 16, which include substantially straight inner sides 25 and outer sides 26 that have a first portion 34 and a second portion 35, advantageously have the thinnest portion of the thickness 27 at a transition point 28 that is radially inside of the outer-most point of the flexure portion 16. This positioning allows optimization of both the torque and bending stresses. Additionally, the diaphragm 11 is constructed of a unitary part. Although in certain circumstances it may still be advantageous to do so, this obviates the need for electron beam welding of adjacent coupling parts used in conventional coupling devices. Also, the flexure space 31 does not narrow in a radially-outward direction. This allows the machining or forming of the flexure space 31 to be more simplified, and thus less expensive and more commercially efficient. It also advantageously requires contouring of only the outer sides 26 of the flexure portion 16 of the diaphragm 11. Although conventional methods may be used, this results in the ability to use methods less expensive and time consuming than the conventional electro-chemical machining.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A flexible coupling device for transmitting power between at least two adjoining rotary members and allowing axial deflection and/or angular misalignment of at least one rotary member relative to another, the flexible coupling device comprising:
one or more unitary diaphragms including;
a hub portion, and
at least two adjacent annular members extending radially outwardly from the hub portion, each annular member being flexible to allow axial misalignment and comprising,
at least one radially-outward connecting portion for connecting each diaphragm to an adjoining diaphragm or rotary member, and
a flexure portion extending radially between the hub portion of the diaphragm and the connecting portion of the respective annular member, wherein the flexure portion comprises an outer side and an inner side,
wherein the inner and outer sides of at least one flexure portion define a thickness for the flexure portion, and a thinnest point of the flexure portion is spaced radially-inward from the radially-outermost point of the flexure portion, and
wherein the inner sides of the adjacent annular members of a diaphragm axially face each other so as to define a flexure space that does not narrow in a radially-outward direction when the annular members are in an unflexed condition.

2. A flexible coupling of claim 1, wherein the connecting portion extends axially in one direction and radially outward from the flexure portion.

3. A flexible coupling of claim 1, wherein the thinnest point of adjacent flexure portions are substantially aligned in an axial direction.

4. A flexible coupling of claim 1, wherein a continuous curve defines the outer side of at least one flexure portion.

5. A flexible coupling of claim 1, wherein the connecting portion is located radially outside of the radially-outermost point of the flexure portion.

6. A unitary diaphragm of a flexible coupling device including;
a hub portion, and
at least two adjacent annular members extending radially outwardly from the hub portion, each annular member being flexible to allow axial deflection and/or angular misalignment and comprising,
at least one radially-outward connecting portion for connecting each diaphragm to an adjoining diaphragm or rotary member, and
a flexure portion extending radially between the hub portion of the diaphragm and the connecting portion of the respective annular member, wherein the flexure portion comprises an outer side and an inner side,
wherein the inner and outer sides of at least one flexure portion define a thickness for the flexure portion, and a thinnest point of the flexure portion is spaced radially-inward from the radially-outermost point of the flexure portion, and
wherein the inner sides of the adjacent annular members of a diaphragm axially face each other so as to define a flexure space that does not narrow in a radially-outward direction when the annular members are in an unflexed condition.

7. A flexible coupling of claim 6, wherein said connecting portion extends axially in one direction and radially outward from the flexure portion.

8. A flexible coupling of claim 6, wherein the thinnest point of adjacent flexure portions are substantially aligned in an axial direction.

9. A flexible coupling of claim 6, wherein a continuous curve defines the outer side of at least one flexure portion.

10. A flexible coupling of claim 6, wherein the connecting portion is located radially outside of the radially-outermost point of the flexure portion.

11. A method of manufacture for a unitary diaphragm of a flexible coupling device for transmitting power between at least two adjoining rotary members and allowing axial deflection and/or angular misalignment of at least one rotary member relative to another, the method of manufacture comprising:
forming outer sides of flexure portions of at least two annular members that extend radially outwardly from a hub portion of a diaphragm; and
forming a flexure space that does not narrow and that defines inner sides of adjacent annular members,
wherein the step of forming outer sides further comprises forming inner and outer sides of at least one flexure portion so as to define a thickness for the flexure portion, wherein the thinnest point of the flexure portion is spaced radially-inward from the radially-outermost point of the flexure portion.

12. A method of manufacture of claim 11, further comprising forming a connecting portion that extends axially in one direction and radially outward from the flexure portion.

13. A method of manufacture of claim 11, further comprising forming the unitary diaphragm using conventional machining means.

14. A method of manufacture of claim 11, further comprising forming the outer sides of at least one flexure portion so that the outer side is defined by a continuous curve.

15. A method of manufacture of claim 11, further comprising forming a connecting portion located at the radially-outermost point of the flexure portion.
